(19) United States
(12) Patent Application Publication
(10) Pub. No.: US 2015/0050053 A1
(43) Pub. Date: Feb. 19, 2015

(54) DEVELOPING DEVICE AND IMAGE FORMING APPARATUS INCLUDING THE SAME

(71) Applicant: Samsung Electronics Co., Ltd., Suwon-si (KR)

(72) Inventors: Sung Jin KIM, Suwon-si (KR); Dae Ho Kim, Seoul (KR); Hyun Wook Bae, Yongin-si (KR)

(73) Assignee: Samsung Electronics Co., Ltd., Suwon-si (KR)

(21) Appl. No.: 14/457,481

(22) Filed: Aug. 12, 2014

(30) Foreign Application Priority Data
Aug. 13, 2013 (KR) 10-2013-0095928

(51) Int. Cl. G03G 15/08

(52) U.S. Cl. CPC G03G 15/0889
USPC 399/254

(57) ABSTRACT

A developing device configured such that developer is uniformly distributed in the developing device, thereby preventing deterioration of image quality due to poor supply of the developer and preventing damage to an agitating device due to the developer non-uniformly distributed in the developing device, and an image forming apparatus including the same are provided.

### CROSS-REFERENCE TO RELATED APPLICATIONS

This application is related to, and claims the priority benefit of Korean Patent Application No. 10-2013-0095928, filed on Aug. 13, 2013 in the Korean Intellectual Property Office, the disclosure of which is incorporated herein by reference.

### BACKGROUND

1. Field

Embodiments relate to a developing device having a structure to agitate developer stored in a developer receiving compartment and an image forming apparatus including the same.

2. Description of the Related Art

An image forming apparatus forms an image on a sheet according to an input signal. Types of image forming apparatuses include a printer, copier, facsimile, and a multifunction device having functions of the printer, copier, and facsimile.

An electrophotographic image forming apparatus, which is a kind of image forming apparatus, includes a photoconductor, an optical scanning device, and a developing device. The optical scanning device scans light to the photoconductor, which is charged with a predetermined potential, to form an electrostatic latent image on the surface of the photoconductor. The developing device supplies a developer to the photoconductor, on which the electrostatic latent image is formed, to form a visible image.

The visible image formed on the photoconductor is directly transferred to a sheet. Alternatively, the visible image is transferred to a sheet via an intermediate transfer device. The image transferred to the sheet is fixed to the sheet by fusing.

Generally, the developing device includes a developer receiving compartment, a developer feeding device, and a developing member. The developer receiving compartment stores developer. The developer feeding device feeds the developer from the developer receiving compartment to the developing member. The developing member supplies the developer to the photoconductor to form a visible image on the photoconductor.

### SUMMARY

It is an aspect of an exemplary embodiment to provide a developing device having a developer agitating device to uniformly distribute developer in the developing device and a structure to prevent damage to a rotary member due to overload caused due to developer non-uniformly distributed in the developing device and an image forming apparatus including the same.

Additional aspects will be set forth in part in the description which follows and, in part, will be obvious from the description, or may be learned by practice of the invention.

In accordance with an aspect of an embodiment, a developing device includes a housing having a developer receiving compartment defined therein, a first rotary member mounted in the developer receiving compartment, the first rotary member being provided at one side thereof with a first coupling in a protruding state, an agitating gear connected to one side of the rotary member, the agitating gear being provided with a second coupling engaged with the first coupling provided at the first rotary member, the agitating gear being connected to a drive unit, and an elastic member provided at the other side of the first rotary member to provide elastic force in a direction to push the first rotary member to the agitating gear side.

When the first rotary member is not rotated due to a developer non-uniformly distributed in the developer receiving compartment, the second coupling may pass a side of the first coupling of the first rotary member by sliding.

The first rotary member may repeatedly perform reciprocation in which the first rotary member is moved to the other side of the first rotary member and, when the second coupling has passed the first coupling of the first rotary member, the rotary member may be moved to the agitator gear side.

A developer transferring member may be moved according to the reciprocation of the first rotary member to agitate the developer in the developer receiving compartment.

The reciprocation of the first rotary member may be repeated until the developer is uniformly distributed in the developer receiving compartment such that the rotary member may be rotated together with the agitating gear.

When the second coupling slides along the side of the first coupling of the first rotary member, the first rotary member may be moved to the other side of the first rotary member and the elastic member may be contracted.

When the second coupling has passed the first coupling of the first rotary member, the first rotary member may be moved to the agitator gear side by elastic force of the elastic member such that the second coupling is engaged with the first coupling of the first rotary member.

The housing may include a base frame and an upper frame and the first rotary member, a second rotary member, and the developer transferring member may be provided at the base frame.

The base frame may be provided at an inside thereof with a hole and the other side of the first rotary member may be inserted into the hole such that the first rotary member is rotatably mounted at the base frame.

The hole may have a depth greater than a length of the first rotary member inserted into the hole.

The hole may have a depth greater than at least a length of the first rotary member inserted into the hole by a length equivalent to a height of the coupling of the first rotary member.

The rotary member may be provided at an outside of the other side thereof with an elastic member support part in a protruding state and the elastic member may provide elastic force in a direction to push the elastic member support part to the agitating gear while being supported by the elastic member support part.

When the developer is uniformly distributed in the developer receiving compartment such that the rotary member is rotated, the coupling of the first rotary member may be rotated while being engaged with the coupling of the agitating gear.

At least one selected from between one side of the coupling of the agitating gear and one side of the coupling of the first rotary member contacting the side of the coupling of the agitating gear may be more gently inclined than the other.

The other side of the agitating gear may be rotated by power transmitted from a motor and the first rotary member may be rotated in a state in which the first coupling is engaged with the coupling of the agitating gear.

In accordance with an aspect of an exemplary embodiment, an image forming apparatus includes an apparatus body forming an external appearance thereof, a photoconductor, disposed in the apparatus body, on which an electrostatic latent image is formed, and a developing device to supply developer to the photoconductor, wherein the developing device includes a housing having a developer receiving compartment to receive developer defined therein, a first rotary member rotatably mounted in the developer receiving compartment, an agitating gear connected to one side of the first rotary member to transmit rotational force to the first rotary member, and an elastic member mounted at the first rotary member to provide elastic force in a direction to push the first rotary member to agitating gear side, and wherein the agitating gear is provided at one side thereof with a second coupling, the rotary member is provided at one side thereof with a first coupling engaged with the second coupling, and the second coupling and the first coupling are rotated in an engaged state.

When the first rotary member is not rotated due to the developer non-uniformly distributed in the developer receiving compartment, the second coupling may be rotated such that the second coupling slides along the side of the first coupling and passes the first coupling.

When the second coupling slides along the side of the first coupling, the first rotary member may be moved to the other side of the first rotary member and, when the second coupling has passed the first coupling, the first rotary member may be moved to the agitator gear side by elastic force of the elastic member such that the second coupling is engaged with the first coupling.

The first rotary member repeatedly performs reciprocation in which the rotary member is moved to the other side of the first rotary member and then moved to the agitator gear side until the rotary member is rotatable to agitate the developer in the developer receiving compartment.

At least one selected from between one side of the second coupling and one side of the first coupling contacting the side of the second coupling may be more gently inclined than the other.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a view illustrating an image forming apparatus according to an embodiment;

FIG. 2 is a sectional view illustrating a developing device according to an embodiment;

FIGS. 3A-3C illustrate exemplary partial views of a developing device according to an embodiment;

FIG. 4A is a view illustrating a developer feeding device according to an embodiment;

FIG. 4B is a view illustrating a developer feeding device according to an embodiment;

FIG. 4C is a view illustrating a developer feeding device according to an embodiment;

FIG. 5 is a view illustrating a first rotary member with an agitating device according to an embodiment;

FIGS. 6 and 7 are partial exploded views of a first rotary member, to which an agitating device according to an embodiment is connected;

FIG. 8 is a partial view illustrating a first rotary member according to an embodiment;

FIG. 9 is a partial view illustrating an agitating gear according to an embodiment;

FIGS. 10 and 11 are views illustrating a state of a first rotary member according to rotation of the agitating gear according to an embodiment;

FIG. 12 is a view illustrating an exemplary normal state of a first rotary member when the developing device according to an embodiment;

FIG. 13 is a view illustrating an exemplary abnormal state of the first rotary member when the developing device according to an embodiment;

FIG. 14 is a partial view illustrating a developing unit, in which a developing part and a developer receiving part are separated from each other, according to an embodiment; and

FIG. 15 is exemplary partial sectional view of a developing unit FIG. 14.

### DETAILED DESCRIPTION

Reference will now be made in detail to the embodiments, examples of which are illustrated in the accompanying drawings, wherein like reference numerals refer to like elements throughout.

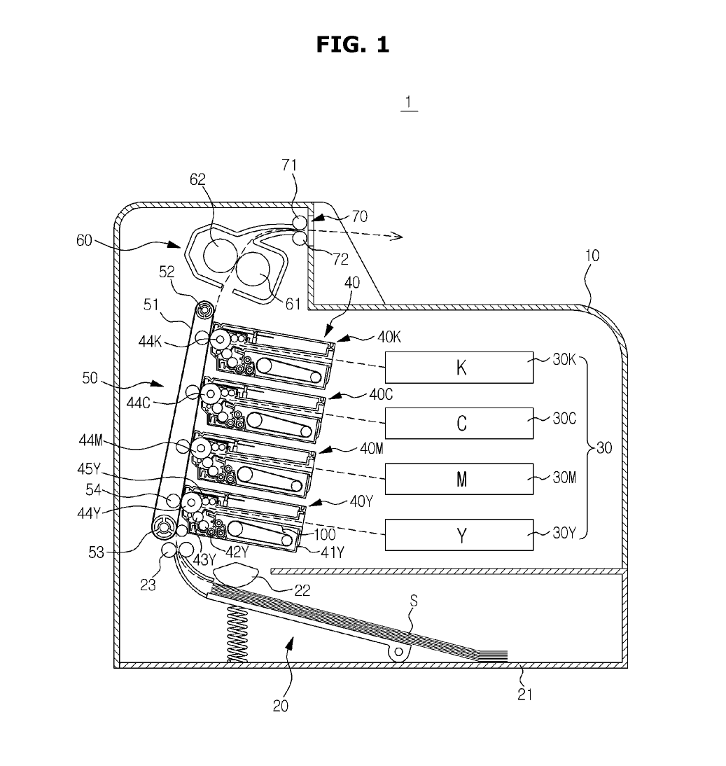

FIG. 1 is a view illustrating an image forming apparatus according to an embodiment.

As illustrated in FIG. 1, the image forming apparatus 1 includes an apparatus body 10, a sheet supply unit 20, an optical scanning unit 30, a developing unit 40, a transfer unit 50, a fusing unit 60, and a sheet discharge unit 70.

The apparatus body 10 supports various components disposed therein while forming the external appearance of the image forming apparatus 1.

The sheet supply unit 20 includes a cassette 21 to store sheets S, a pickup roller 22 to pick up the sheets S stored in the cassette 21, for example, one-by-one, and a feeding roller 23 to feed each picked-up sheet to the transfer unit 50.

The optical scanning unit 30 includes, for example, four optical scanners 30Y, 30M, 30C, and 30K to respectively scan light corresponding to image information including, for example, yellow (Y), magenta (M), cyan (C), and black (K) to photoconductors 44Y, 44M, 44C, and 44K of developing devices 40Y, 40M, 40C, and 40K, according to a print signal. Electrostatic latent images may be formed on the photoconductors 44Y, 44M, 44C, and 44K according to light scanned to the four optical scanners 30Y, 30M, 30C, and 30K.

The developing unit 40 includes, for example, four developing devices 40Y, 40M, 40C, and 40K to receive different color developers, such as yellow, magenta, cyan, and black developers.

The developing device 40Y to receive the yellow (Y) developer are described by way of example. The following description may be applied to other three devices 40M, 40C, and 40K to receive the magenta (M), cyan (C), and black (K) developers, unless particularly specified otherwise.

The transfer unit 50 transfers a visible image formed on the photoconductor 44Y to a sheet. The transfer unit 50 includes a sheet feeding belt 51, a driving roller 52, a driven roller 53, and a plurality of transfer rollers 54.

The sheet feeding belt 51 feeds a sheet supplied from the sheet supply unit 20 to the photoconductors 44Y, 44M, 44C, and 44K.

The driving roller 52 and the driven roller 53 may be mounted at inner opposite ends of the sheet feeding belt 51 such that the sheet feeding belt 51 may be endlessly driven.

The transfer rollers 54 may face the photoconductors 44Y, 44M, 44C, and 44K in a state in which the sheet feeding belt 51 is disposed therebetween to transfer the visible images formed on the photoconductors 44Y, 44M, 44C, and 44K to the sheet fed by the sheet feeding belt 51.

The fusing unit 60 includes a heating roller 61 having a heat source and a pressing roller 62 opposite to the heating roller 61. When a sheet passes through a space between the heating roller 61 and the pressing roller 62, the transferred images are fixed on the sheet by heat transmitted from the heating roller 61 and pressure generated between the heating roller 61 and the pressing roller 6.

The sheet discharge unit 70, including a sheet discharge roller 71 and a sheet discharge backup roller 72, discharges the sheet having passed through the fusing unit 60 out of the apparatus body 10.

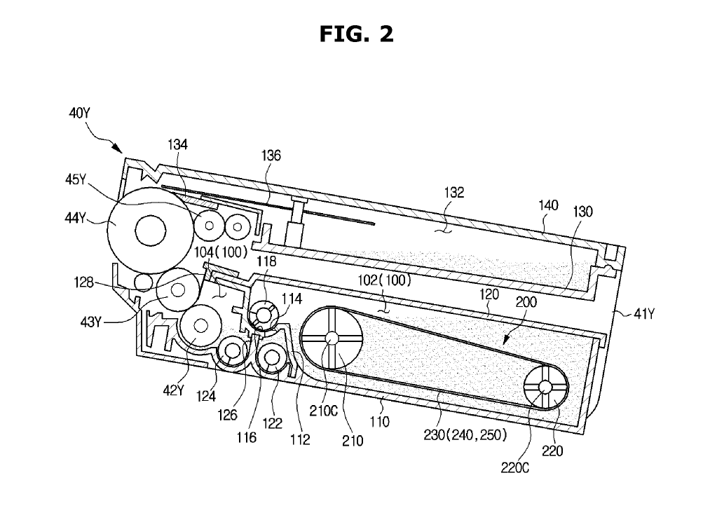

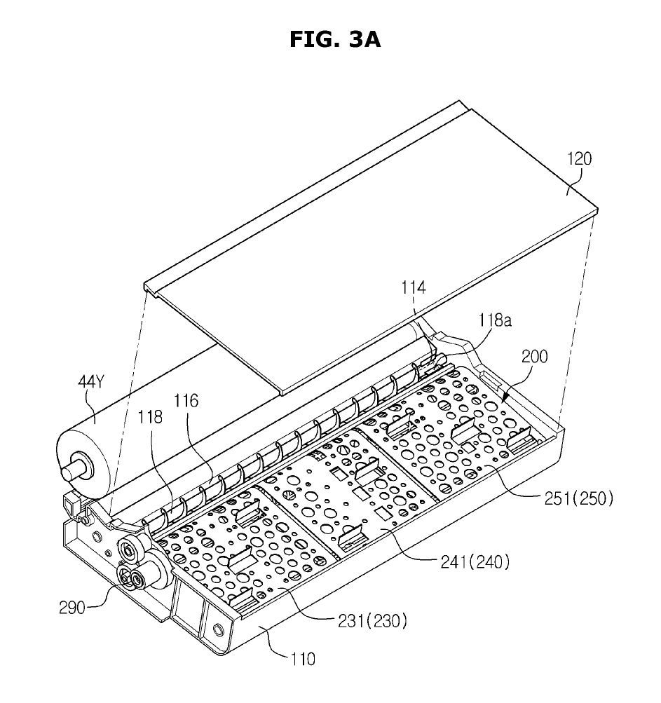

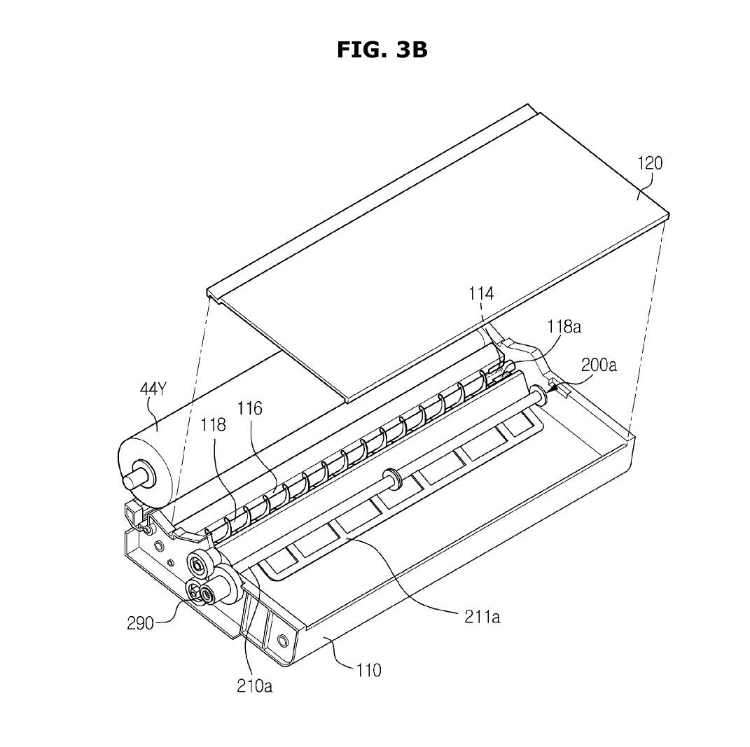

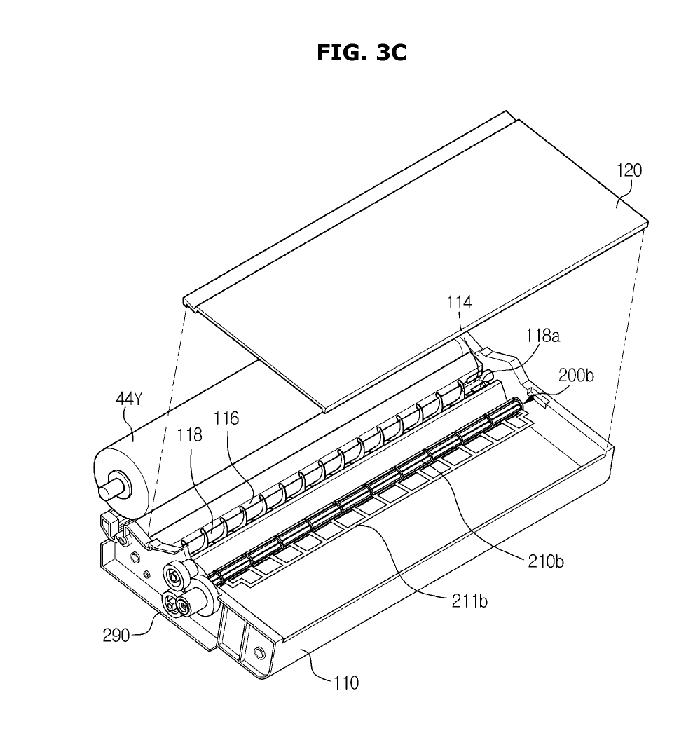

FIG. 2 is a sectional view illustrating a developing device according to an embodiment. FIGS. 3A-3C are exemplary partial views of the developing device according to an embodiment.

Referring to FIGS. 2 and 3A-3C, the developing device 40Y includes a housing 41Y, a developer receiving compartment 100, a developer supply member 42Y, a developing member 43Y, and a photoconductor 44Y.

The housing 41Y includes a base frame 110, a cover 120, an upper frame 130, and an upper cover 140.

The base frame 110 supports various components received therein. The cover 120 covers the top of the base frame 110 to define the developer receiving compartment 100 to store developer together with the base frame 110.

The upper frame 130 and the upper cover 140 may be disposed above the cover 120 to define a waste developer receiving compartment 132 to store waste developer collected from the photoconductor 44Y.

A cleaning member 134 may be mounted at the upper frame 130. The cleaning member 134 removes residual developer from the surface of the photoconductor 44Y. The waste developer removed by the cleaning member 134 may be fed by a waste developer transferring member 136 and then stored in the waste developer receiving compartment 132.

The waste developer transferring member 136 may be disposed above the cleaning member 134. The waste developer transferring member 136 may be a plate type member. The waste developer transferring member 136 may be formed of a plastic molding or a film exhibiting high elastic restoring force. In a case in which the waste developer transferring member 136 is a plate type member, the waste developer may be effectively fed even when the height of the waste developer receiving compartment 132 decreases due to reduced height of the developing device 40Y.

The developer receiving compartment 100 may be partitioned into a first developer receiving compartment 102 and a second developer receiving compartment 104 by a partition 112. The first developer receiving compartment 102 and the second developer receiving compartment 104 vertically communicate with each other through inlet port 114 formed at one side of the partition 112.

A developer feeding device 200 may be disposed in the first developer receiving compartment 102. The developer feeding device 200 feeds some of the developer stored in the first developer receiving compartment 102 to the second developer receiving compartment 104. The developer feeding device 200 may serve to feed the developer and, in addition, to agitate the developer in the first developer receiving compartment 102.

The developer stored in the first developer receiving compartment 102 may be fed to the upper side of the first developer receiving compartment 102 by the developer feeding device 200 and then supplied to a developer location part 116 provided at the partition 112. The developer supplied to the developer location part 116 may be fed to one side of the partition 112 by a supply auger 118 and then freely falls into the second developer receiving compartment 104 through the inlet port 114.

A first circulation auger 122, a second circulation auger 124, the developer supply member 42Y, and the developing member 43Y may be disposed in the second developer receiving compartment 104.

The developer having fallen into the second developer receiving compartment 104 through the inlet port 114 of the partition 112 may be circulated by the first circulation auger 122 and the second circulation auger 124, between which a circulation wall 126 may be disposed. During this circulation, the developer may be supplied to the developing member 43Y via the developer supply member 42Y. The developer supplied to the developing member 43Y may be attached to the surface of the photoconductor 44Y, on which the electrostatic latent image has been formed by the optical scanner 30Y, while the layer of the developer is regulated by a regulator 128 to form a visible image.

The supply auger 118, the first circulation auger 122, the second circulation auger 124, the developer supply member 42Y, and the developing member 43Y of FIG. 2 are illustrative as supplying the developer to the photoconductor 44Y. However, embodiments are not limited thereto. For example, the developer supply member 42Y may be omitted in a two component developing mode. Furthermore, although the developer supply member 42Y or the developing member 43Y is illustrated as a cylindrical roller in FIG. 2, embodiments are not limited thereto. The developer supply member 42Y or the developing member 43Y may be a belt or brush type member. Moreover, the supply auger 118, the first circulation auger 122, the second circulation auger 124 illustrated in FIG. 2 may be replaced with other feeding members.

When a sufficient amount of developer is supplied into the second developer receiving compartment 104, introduction of developer through the inlet port 114 may be interrupted and developer having not been introduced through the inlet port 114 is returned to the developer feeding device 200 by a return blade 118a provided at the end of the supply auger 118 corresponding in position to the inlet port 114.

The developer receiving compartment 100 may be defined in the housing 41Y to store developer to be supplied to the photoconductor 44Y. The developer supply member 42Y may be mounted in the housing 41Y to supply the developer stored in the developer receiving compartment 100 to the developing member 43Y. The developing member 43Y attaches the developer to the surface of the photoconductor 44Y, on which the electrostatic latent image has been formed by the optical scanner 30Y, to form a visible image. The photoconductor 44Y may be rotatably mounted at the tip of the housing 41Y to receive the developer from the developing member 43Y. The photoconductor 44Y and the developing device 40Y may be integrated. According to an embodiment, the photoconductor 44Y and the developing device 40Y may be separately provided.

Reference character 45Y indicates a charging roller to charge the photoconductor 44Y with predetermined potential before the optical scanner 30Y scans light to the photoconductor 44Y.

The developer feeding device 200 feeds some of the developer stored in the first developer receiving compartment 102 to the second developer receiving compartment 104. The developer feeding device 200 may serve to feed the developer and, in addition, to agitate the developer in the first developer receiving compartment 102.

The developer stored in the first developer receiving compartment 102 may be fed to the upper side of the first developer receiving compartment 102 by the developer feeding device 200 and is then supplied to a developer location part 116 provided at the partition 112. The developer supplied to the developer location part 116 is fed to one side of the partition 112 by a supply auger 118 and then freely falls into the second developer receiving compartment 104 through the inlet port 114.

A first circulation auger 122, a second circulation auger 124, the developer supply member 42Y, and the developing member 43Y are disposed in the second developer receiving compartment 104.

The developer having fallen into the second developer receiving compartment 104 through the inlet port 114 of the partition 112 may be circulated by the first circulation auger 122 and the second circulation auger 124, between which a circulation wall 126 is disposed. During this circulation, the developer may be supplied to the developing member 43Y via the developer supply member 42Y. The developer supplied to the developing member 43Y may be attached to the surface of the photoconductor 44Y, on which the electrostatic latent image has been formed by the optical scanner 30Y, while the layer of the developer is regulated by a regulator 128 to form a visible image.

The supply auger 118, the first circulation auger 122, the second circulation auger 124, the developer supply member 42Y, and the developing member 43Y of FIG. 2 are illustrative as supplying the developer to the photoconductor 44Y. However, embodiments are not limited thereto. For example, the developer supply member 42Y may be omitted in a two component developing mode. Furthermore, although the developer supply member 42Y or the developing member 43Y is illustrated as a cylindrical roller in FIG. 2, embodiments are not limited thereto. The developer supply member 42Y or the developing member 43Y may be a belt or brush type member. Moreover, the supply auger 118, the first circulation auger 122, the second circulation auger 124 illustrated in FIG. 2 may be replaced with other feeding members.

When a sufficient amount of developer is supplied into the second developer receiving compartment 104, introduction of developer through the inlet port 114 is interrupted and developer having not been introduced through the inlet port 114 is returned to the developer feeding device 200 by a return blade 118a provided at the end of the supply auger 118 corresponding in position to the inlet port 114.

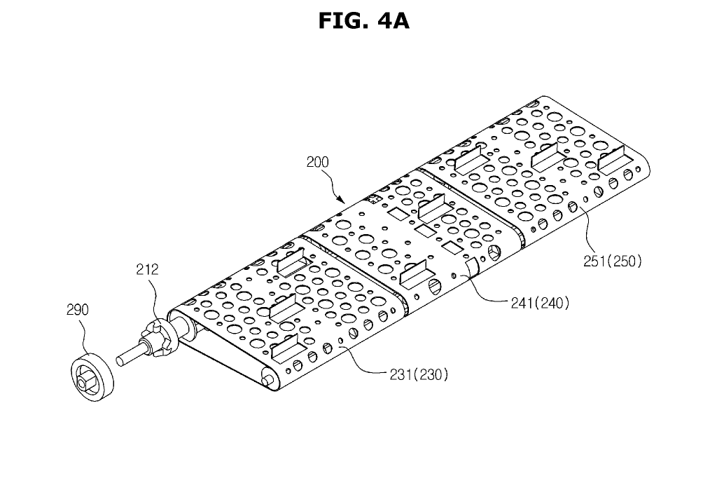

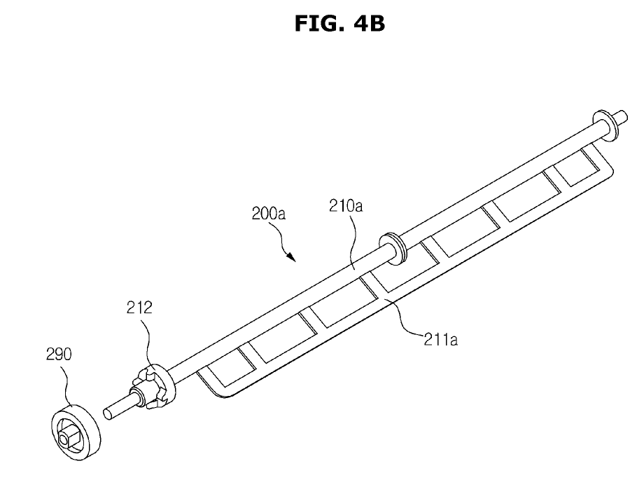

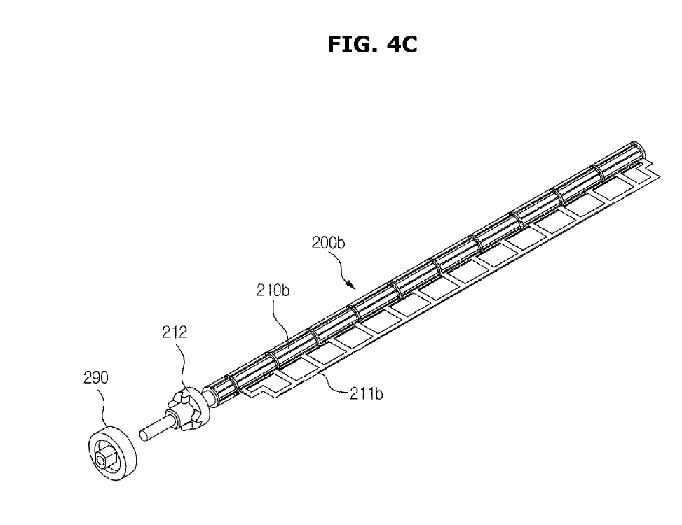

FIG. 4A is a view illustrating a developer feeding device according to an embodiment, FIG. 4B is a view illustrating a developer feeding device according to an embodiment, and FIG. 4C is a view illustrating a developer feeding device according to an embodiment.

As illustrated, for example, in FIGS. 2 and 4A, a developer feeding device 200 may include rotary members 210 and 220 and a plurality of developer transferring members 230, 240, and 250. The rotary members 210 and 220 include a first rotary member 210 and a second rotary member 220. The first rotary member 210 and the second rotary member 220 rotatably support the developer transferring members 230, 240, and 250. The developer transferring members 230, 240, and 250 are rotated around the first rotary member 210 and the second rotary member 220 to feed the developer stored in the first developer receiving compartment 102 to the upper part of the partition 112.

The first rotary member 210 may be disposed in the first developer receiving compartment 102 while being adjacent to the partition 112. The second rotary member 220 may be disposed opposite to the first rotary member 210 while being spaced from the first rotary member 210 by a predetermined distance.

The first rotary member 210 may be rotated by power output from a motor (not illustrated) mounted in the apparatus body 10 to transmit rotation force to the second developer transferring member 240 while supporting one inner side of the second developer transferring member 240. The second rotary member 220 may be rotated together with the developer transferring members 230, 240, and 250 while supporting the other inner side of each of the developer transferring members 230, 240, and 250.

The first rotary member 210 and the second rotary member 220 may be configured to have a spiral blade structure to agitate the developer stored in the first developer receiving compartment 102.

The center of rotation 210C of the first rotary member 210 may be higher than the center of rotation 220C of the second rotary member 220. That is, the center of rotation 210C of the first rotary member 210 may be higher from the bottom of the base frame 110 than the center of rotation 220C of the second rotary member 220. Movement of the developer from the first developer receiving compartment 102 to the second developer receiving compartment 104 due to gravity may be prevented and the developer may be supplied only through feeding forces of the developer transferring members 230, 240, and 250. Consequently, an amount of developer supplied may be effectively controlled.

The developer transferring members 230, 240, and 250 may be belt type members. Developer feeding belts 231, 241, and 251 may be formed in the shape of a film having a thickness of 2 mm or less. The developer feeding belts 231, 241, and 251 may be made of polyethylene terephthalate (PET) or polycarbonate (PC).

The developer feeding belts 231, 241, and 251 may include a first developer feeding belt 231 and a third developer feeding belt 251 disposed at opposite sides of the first rotary member 210 in an axial direction X of the first rotary member 210 and a second developer feeding belt 241 disposed between the first developer feeding belt 231 and the third developer feeding belt 251.

Referring to FIG. 4B, a developer feeding device 200a may include an agitating part 211a formed at the outside of a rotary member 210a. The agitating part 211a may be formed in the shape of a rib protruding outward from the rotary member 210a. The agitating part 211a may be integrated with the rotary member 210a. When the rotary member 210a is rotated, the developer stored in the first developer receiving compartment may be agitated by the agitating part 211a. The developer may be fed from the first developer receiving compartment to the second developer receiving compartment by the agitating part 211a. A plurality of rotary members 210a, each having the agitating part 211a, may be provided.

Referring to FIG. 4C, a developer feeding device 200b may include an agitating film 211b provided at the outside of a rotary member 210b. When the rotary member 210b is rotated, the developer stored in the first developer receiving compartment may be agitated by the agitating film 211b. The developer may be fed from the first developer receiving compartment to the second developer receiving compartment by the agitating film 211b. A plurality of rotary members 210b, each having the agitating film 211b, may be provided.

The first rotary member 210, the rotary member 210a, and the rotary member 210b may be provided an agitating device to agitate developer non-uniformly distributed in the developer receiving compartment. An exemplary embodiment of an agitating device mounted to the first rotary member 210 is described. The exemplary construction of the agitating device may be similarly applied to the rotary member 210a and the rotary member 210b.

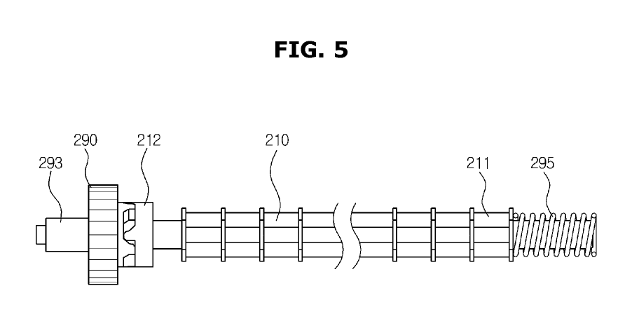

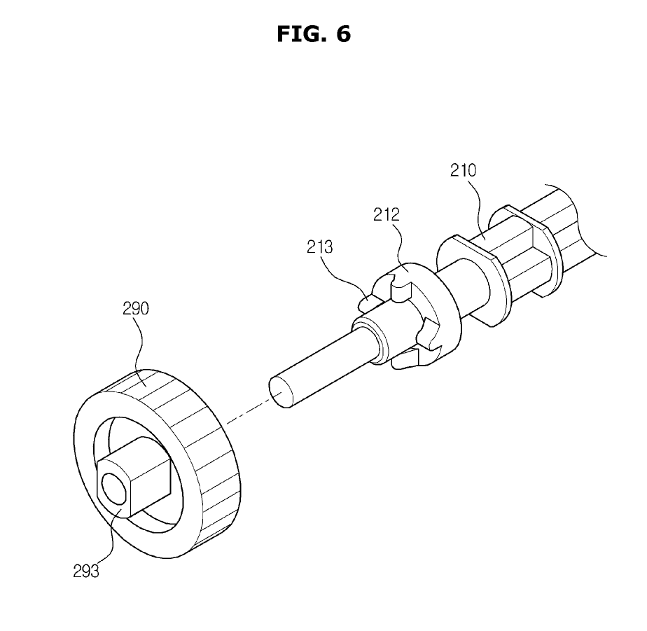

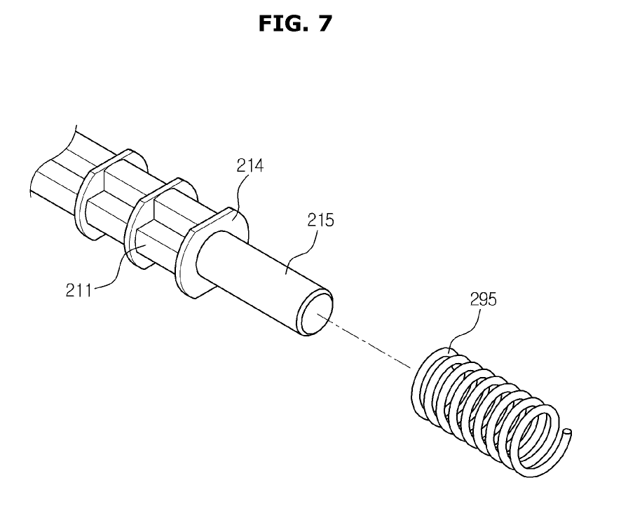

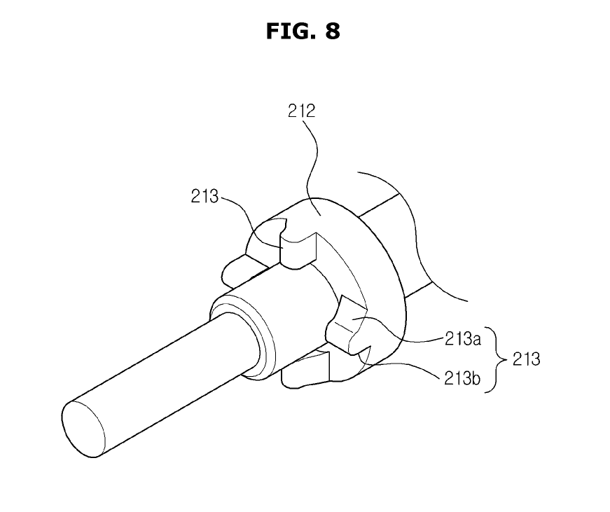

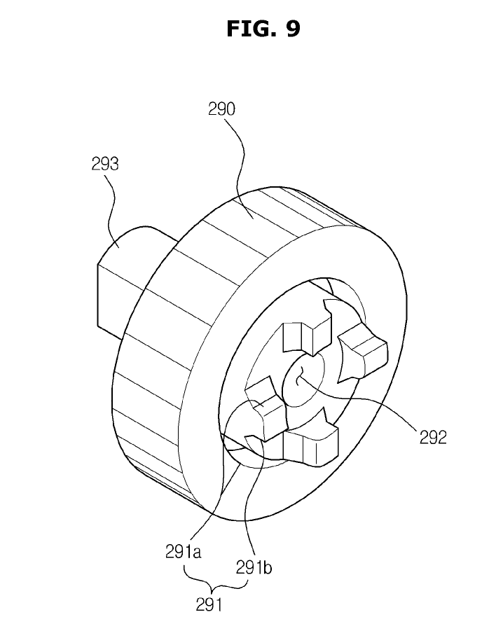

FIG. 5 is a view illustrating a first rotary member with an agitating device according to an embodiment, FIGS. 6 and 7 are partial exploded views of the first rotary member, to which the agitating device according to the embodiment is connected, FIG. 8 is a partial view illustrating a first rotary member according to an embodiment, and FIG. 9 is a partial view illustrating an agitating gear according to an embodiment.

Referring to FIGS. 5 to 9, an agitating gear 290 may be connected to one side of the first rotary member 210. The first rotary member 210 may be rotated by power transmitted from the motor (not illustrated) mounted in the apparatus body 10 via the agitating gear 290.

A gear connection part 212 may be provided at one side of the first rotary member 210. A first coupling 213 may protrude from one side of the gear connection part 212 in the axial direction. A plurality of first couplings 213 may be provided.

The first couplings 213 formed at the gear connection part 212 may be formed so as to correspond to a second coupling 291 formed at the agitating gear 290. A plurality of second couplings 291 may be provided.

At least one side of the first coupling 213 formed at the first rotary member 210 may be gently inclined. When the agitating gear 290 is mounted to the first rotary member 210, at least one selected from between the second coupling 291 formed at the agitating gear 290 and the first coupling 213 contacting the second coupling 291 may be more gently inclined than the other. When the first rotary member 210 is not rotated due to solidified developer non-uniformly distributed in the developer receiving compartment, therefore, the second coupling 291 may easily slide along one side of the first coupling 213 and pass the first coupling 213. As the second coupling 291 slides along one side of the first coupling 213, the first rotary member 210 may be rotated in the axial direction.

For example, on the assumption that opposite sides of the first coupling 213 are a first side 213a and a second side 213b, an angle between the first side 213a and an extension line of the first rotary member 210 may be greater than 0° and an angle between the second side 213b and the extension line of the first rotary member 210. The first side 213a and the second side 213b may be gently inclined. In the following description, the first side 213a may be gently inclined and the second side 213b may be steeper than the first side 213a.

A second coupling 291 may protrude from one side of the agitating gear 290 in the axial direction. A plurality of second couplings 291 may be provided. The second couplings 291 formed at the agitating gear 290 may correspond in shape to the first coupling 213 formed at the gear connection part 212 of the first rotary member 210. The second couplings 291 formed at the agitating gear 290 may be engaged with the first coupling 213 formed at the gear connection part 212.

At least one side of the second coupling 291 formed at the agitating gear 290 may be gently inclined. For example, on the assumption that opposite sides of the second coupling 291 are a third side 291a and a fourth side 291b, the third side 291a may be gently inclined and the fourth side 291b may be steeper than the third side 291a.

The gently inclined third side 291a may contact the steep second side 213b and the steep fourth side 291b may contact the gently inclined first side 213a. That is, when the agitating gear 290 is mounted to the first rotary member 210, the second coupling 291 formed at the agitating gear 290 may be engaged with the first coupling 213 formed at the first rotary member 210 and at least one selected from between one side of the second coupling 291 and one side of the first coupling 213 which contact each other may be more gently inclined than the other. When overload is applied to the first rotary member 210, therefore, the second coupling 291 may slide along one side of the first coupling 213 formed at the first rotary member 210.

As the second coupling 291 slides along one side of the first coupling 213, the first rotary member 210 may move in the axial direction. As the second coupling 291 continuously slides along one side of the first coupling 213, the first rotary member 210 may be reciprocated in the axial direction. As a result, the developer may be agitated and uniformly distributed in the developer receiving compartment 102.

A drive device connection part 293 may be provided at the other side of the agitating gear 290. The drive device connection part 293 may be directly connected to the motor or another gear part connected to the motor. Consequently, driving force may be transmitted to the first rotary member 210, to which the agitating gear 290 is connected.

The other side of the first rotary member 210 may be rotatably mounted in the first developer receiving compartment 102. For example, a hole 106 may be formed at the inside of the base frame 110 defining the first developer receiving compartment 102 and the other side of the first rotary member 210 may be rotatably inserted into the hole 106. The depth of the hole 106 may be greater than the length of the first rotary member 210 inserted into the hole 106. Specifically, the depth of the hole 106 may be greater than the length of the first rotary member 210 inserted into the hole 106 by a length equivalent to the height of the first coupling 213.

An elastic member 295 may be mounted at the other side of the first rotary member 210. The elastic member 295 provides elastic force to push the first rotary member 210 to the agitator gear 290 side. That is, the elastic member 295 may transmit elastic force to the first rotary member 210 such that the first rotary member 210 moves in a direction opposite to the direction in which the first rotary member 210 is pushed by the second coupling 291.

An elastic member mounting part 215 may be mounted at the other side of the first rotary member 210. An elastic member support part 214 may protrude from the outside of the first rotary member 210 at a position adjacent to the elastic member mounting part 215. The elastic member 295 may be mounted in the elastic member mounting part 215. The elastic member 295 mounted in the elastic member mounting part 215 pushes the elastic member support part 214 while being supported by the elastic member support part 214. Consequently, the elastic member 295 may push the first rotary member 210 to the agitator gear 290 side.

A portion of the elastic member mounting part 215 may be inserted into a hole formed at the base frame 110. The elastic member may be interposed between the inside of the base frame 110 and the elastic member support part 214 to provide elastic force to push the first rotary member 210 to the agitator gear 290 side.

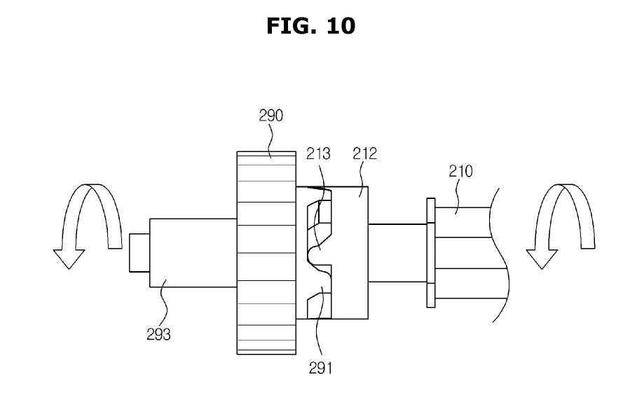

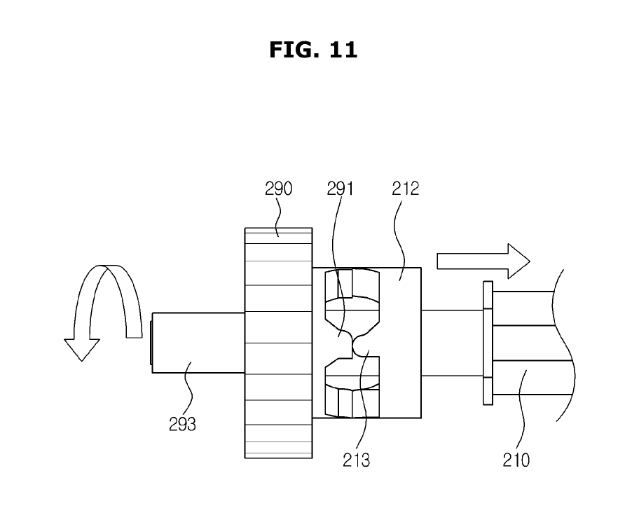

FIGS. 10 and 11 are views illustrating a state of the first rotary member according to rotation of the agitating gear according to the embodiment.

Referring to FIG. 10, when the agitator gear 290 is rotated in a normal state, the first rotary member 210, to which the agitator gear 290 is connected, may also be rotated. A normal state may be defined as a state in which developer is uniformly distributed in the first developer receiving compartment 102 or a state in which the first rotary member 210 is rotated while overload is not applied to the first rotary member 210 although developer accumulates at one side in the first developer receiving compartment 102. When the first rotary member 210 is rotated, the developer transferring members 230, 240, and 250 may also be rotated to agitate the developer stored in the first developer receiving compartment 102.

Referring to FIG. 11, when a driving force of the motor is transmitted to the agitator gear 290 in an abnormal state, overload caused by non-uniformly distributed developer may be applied to the first rotary member 210, to which the agitator gear 290 is connected, with the result that the first rotary member 210 is not rotated. An abnormal state may be defined as a state in which developer is solidified while accumulating at one side in the first developer receiving compartment 102 and thus overload is applied to the first rotary member 210 when the first rotary member 210 is rotated.

A driving force of the motor may be continuously transmitted to the agitator gear 290 and the second coupling 291 of the agitating gear 290 may slide along the side of the coupling 213 of the first rotary member 210. Since at least one selected from between the side of the second coupling 291 and the side of the first coupling 213 which contact each other may be gently inclined, the second coupling 291 of the agitating gear 290 may slide along the side of the first coupling 213 of the first rotary member 210 and pass the first coupling 213. When the second coupling 291 passes the first coupling 213 of the first rotary member 210 by sliding, the elastic member 295 provided at the other side of the first rotary member 210 may be contracted by force applied in an opposite direction to the elastic force. Consequently, the first rotary member 210 is pushed to the other side according to rotation of the agitating gear 290 with the result that the second coupling 291 may pass the first coupling 213 of the first rotary member 210.

Hereinafter, an exemplary operation of the first rotary member depending on a state of the developing device is described with reference to the drawings.

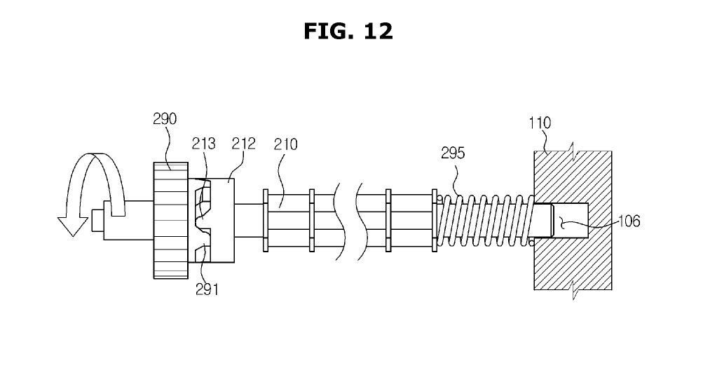

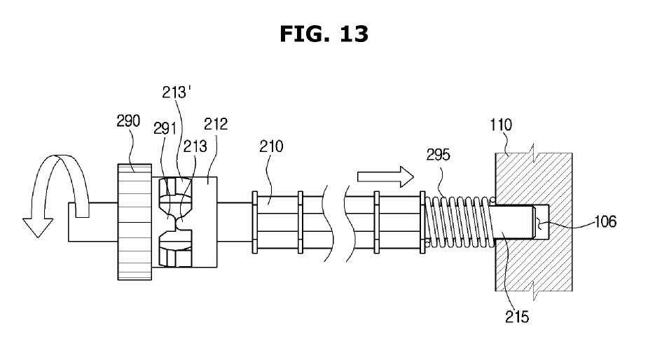

FIG. 12 is a view illustrating an exemplary state of the first rotary member when the developing device according to an embodiment is normal. FIG. 13 is a view illustrating a state of the first rotary member when the developing device according to an embodiment is abnormal.

Referring to FIG. 12, in a normal state in which developer is uniformly distributed in the first developer receiving compartment 102 or the first rotary member 210 may be rotated while overload is not applied to the first rotary member 210 although the developer is non-uniformly distributed in the first developer receiving compartment 102, the first rotary member 210 may be rotated in a state in which the first coupling 213 provided at the first rotary member 210 is engaged with the second coupling 291 formed at the agitating gear 290. The elastic member 295 provided at the other side of the first rotary member 210 provides force to push the first rotary member 210 to the agitating gear 290 side to maintain engagement between the first coupling 213 of the first rotary member 210 and the second coupling 291.

In the normal state, the first rotary member 210 may be rotated by the agitating gear 290 to rotate the developer transferring members, which agitate the developer in the first developer receiving compartment 102 such that the developer is uniformly distributed in the first developer receiving compartment 102.

Referring to FIG. 13, in an abnormal state in which developer is solidified while being non-uniformly distributed in the first developer receiving compartment 102 and thus overload is applied to the first rotary member 210 when the first rotary member 210 is rotated, the agitator gear 290 may be rotated by driving force transmitted from the motor and the first rotary member 210 is not rotated by the developer accumulating at one side in the first developer receiving compartment 102. The agitator gear 290 may be rotated and the side of the second coupling 291 may slide along the side of the first coupling 213 of the first rotary member 210. The second coupling 291 may slide along the side of the first coupling 213 and pass the first coupling 213. As the second coupling 291 slides along the side of the first coupling 213, the first rotary member 210 is pushed to the other side of the first rotary member 210. The elastic member 295 provided at the other side of the first rotary member 210 is contracted.

When the second coupling 291 passes the first coupling 213, the first rotary member 210 may be moved to the agitator gear 290 side by elastic force of the elastic member 295. The first rotary member 210 may be elastically moved to the agitator gear 290 side by the elastic member 295.

The agitator gear 290 may be continuously rotated by the motor. After passing one first coupling 213, the second coupling 291 may slide along the side of another first coupling, for example, adjacent to the first coupling 213 and pass the another first coupling. The first rotary member 210 may be moved to the other side of the first rotary member 210 by the elastic member 295 and, when the second coupling 291 has passed another first coupling 213, the first rotary member 210 may be elastically moved to the agitator gear 290 side.

In the abnormal state, the agitator gear 290 may be continuously rotated by the motor and the second coupling 291 repeatedly passes the first coupling 213 provided at the first rotary member 210. In a case in which a plurality of first couplings 213 is provided, the second coupling 291 may sequentially pass the first couplings 213 provided at the first rotary member 210.

When the second coupling 291 sequentially passes the first couplings 213 provided at the first rotary member 210, the first rotary member 210 may be repeatedly pushed to the other side of the first rotary member 210 and returned to the agitator gear 290 side.

The developer transferring members 230, 240, and 250 may be repeatedly pushed to the other side of the first rotary member 210 and returned to the agitator gear 290 side together with the first rotary member 210. The developer in the first developer receiving compartment 102 may be uniformly distributed according to reciprocation of the developer transferring members 230, 240, and 250 together with the first rotary member 210.

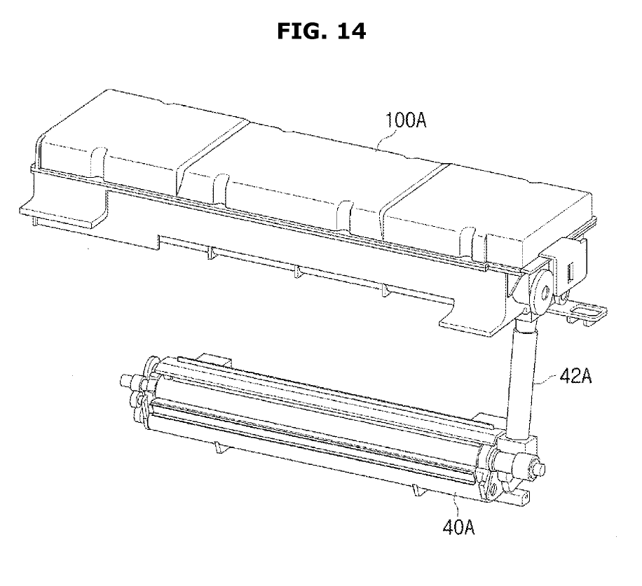

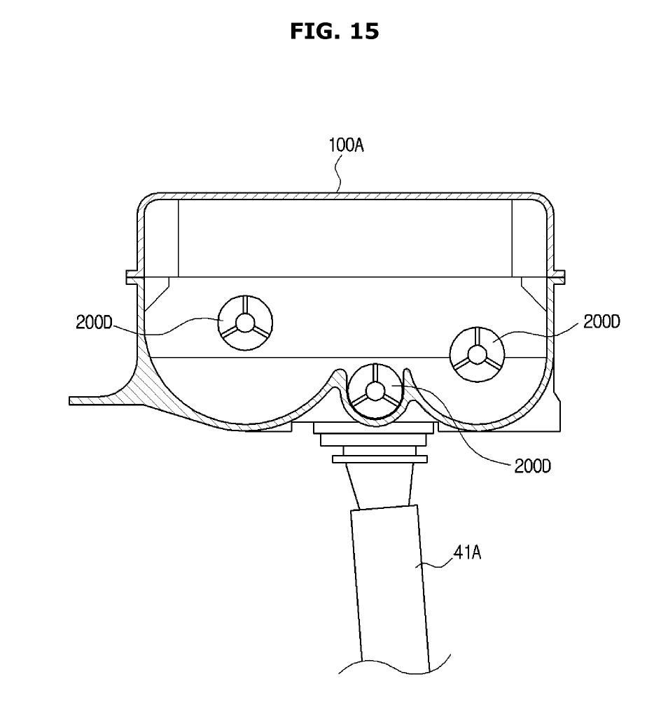

FIG. 14 is a partial view illustrating a developing unit, in which a developing part and a developer receiving part are separated from each other, according to an embodiment and FIG. 15 is an exemplary partial sectional view of FIG. 14.

Referring to FIGS. 14 and 15, the developing unit may include a developing part 40A and a developer receiving part 100A which are separated from each other. The developing part 40A and the developer receiving part 100A may be connected to each other via a supply pipe 42A.

The developer receiving part 100A receives developer. The developer receiving part 100A may be replaced independent of the developing part 40A. The developer receiving part 100A may be provided with a developer supply hole (not illustrated) communicating with the supply pipe 42A.

A developer feeding device 200D may be disposed in the developer receiving part 100A. The developer feeding device 200D may feed the developer received in the developer receiving part 100A to a supply hole (not illustrated) side. The developer feeding device 200D may serve to feed the developer and, in addition, to agitate the developer in the developer receiving part 100A.

Even in a case in which the developer receiving part 100A and the developing part 40A are separated from each other, construction of the developer feeding devices 200, 200a, and 200b illustrated in FIGS. 4A to 4C may be similarly applied to the developer feeding device 200D. That is, the developer feeding device 200D may include a rotary member and a developer transferring member configured to be rotated together with the rotary member may be mounted at the rotary member or an agitating rib or an agitating film may be provided at the outside of the rotary member. When the rotary member is rotated, the developer may be agitated in the developer receiving part 100A by the developer transferring member, the agitating rib, or the agitating film.

A first coupling may protrude from one side of the rotary member in the axial direction. An agitating gear having a second coupling engaged with a first coupling may be provided at one sides of the rotary member. The agitating gear may be connected to a motor. When driving force of the motor is transmitted to the agitating gear and the agitating gear is rotated in a normal state, the rotary member, to which the agitating gear is connected, may be also rotated. When driving force of the motor is transmitted to the agitating gear in an abnormal state, overload caused by the developer non-uniformly distributed in the developer receiving part 100A is applied to the rotary member, to which the agitating gear is connected, with the result that the rotary member is not rotated. When driving force of the motor is continuously transmitted to the agitating gear, the second coupling may slide along the side of the first coupling and pass the first coupling. The rotary member may be pushed to the other side of the rotary member and, when the second coupling passes the first coupling, the rotary member may be elastically moved to the agitator gear side. That is, the rotary member may be elastically biased by rotation of the agitator gear and moved in the axial direction.

A plurality of first couplings and a plurality of second coupling may be provided such that each second coupling may pass one first coupling and then slide along the side of another first coupling to pass the first coupling. The rotary member may be elastically biased by rotation of the agitator gear and repeatedly reciprocated in the axial direction. Consequently, the developer may be agitated and uniformly distributed in the developer receiving part 100A and thus the agitating gear and the rotary member may be simultaneously rotated.

Since the developer is uniformly distributed in the developer receiving compartment, poor image development of the developing device may be prevented, thereby improving quality of the developing device. For example, in a case in which the developer is solidified while accumulating at one side in the developer receiving compartment, the first rotary member 210 may be elastically reciprocated to crush and agitate the solidified developer. When the developer is agitated to such an extent that the first rotary member may be rotated, the first rotary member may be rotated in a state in which the second coupling is engaged with the first coupling of the first rotary member. Consequently, the developer is uniformly distributed in the developer receiving compartment and thus the developing device may efficiently operate.

When the developer is solidified while accumulating at one side in the developer receiving compartment, overload caused by the solidified developer may be applied to the first rotary member. When rotational force is transmitted to the first rotary member, therefore, the first rotary member may not be rotated and even broken. In such an abnormal state, it may be necessary for a user to separate the developing device from the image forming apparatus and to shake the developing device.

However, according to an embodiment, on the other hand, even when the developer is solidified while accumulating at one side in the developer receiving compartment, the first rotary member and the developer transferring member may be elastically reciprocated based on the shape of the second coupling provided at the agitating gear and the first coupling provided at the first rotary member and the structure of the elastic member such that the solidified developer is crushed and uniformly distributed in the developer receiving compartment. Consequently, the first rotary member is prevented from being broken due to overload applied to the first rotary member and quality image may be obtained without separation of the developing device from the image forming apparatus.

As is apparent from the above description, according to exemplary embodiments, the developer is uniformly distributed in the developing device, thereby preventing deterioration of image quality due to poor supply of the developer and preventing damage to the agitating device due to the developer non-uniformly distributed in the developing device.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A developing device comprising:
a housing having a developer receiving compartment defined therein;
a rotary member movably mounted in the developer receiving compartment in an axial direction, the rotary member being provided at one side thereof with a first coupling;
an agitating gear connected to a drive source and one side of the rotary member to transmit power to the rotary member, the agitating gear being provided with a second coupling engaged with the first coupling provided at the rotary member to move the rotary member in the axial direction; and
an elastic member provided at an other side of the rotary member to elastically bias the rotary member to the agitating gear side.

2. The developing device according to claim 1, wherein, when the rotary member is not rotated due to developer non-uniformly distributed in the developer receiving compartment, the second coupling passes a side of the first coupling of the rotary member by sliding to move the rotary member in the axial direction.

3. The developing device according to claim 2, wherein the rotary member repeatedly performs reciprocation in which the rotary member is moved to an other side of the rotary member and, when the second coupling has passed the first coupling of the rotary member, the rotary member is moved to the agitator gear side such that the rotary member is repeatedly reciprocated in the axial direction.

4. The developing device according to claim 3, wherein a developer transferring member is also moved according to the reciprocation of the rotary member to agitate the developer in the developer receiving compartment.

5. The developing device according to claim 4, wherein the reciprocation of the rotary member is repeated until the developer is uniformly distributed in the developer receiving compartment such that the rotary member is rotated together with the agitating gear.

6. The developing device according to claim 2, wherein, when the second coupling slides along the side of the first coupling of the rotary member, the rotary member is moved to the other side of the rotary member and the elastic member is contracted.

7. The developing device according to claim 6, wherein, when the second coupling has passed the first coupling of the rotary member, the rotary member is moved to the agitator gear side by elastic force of the elastic member such that the second coupling is engaged with the first coupling of the rotary member.

8. The developing device according to claim 1, further comprising:
another rotary member disposed in the developer receiving compartment while being spaced from the rotary member by a predetermined distance; and
a plurality of developer transferring members arranged in the axial direction of the rotary member to rotate around the rotary member and the another rotary member.

9. The developing device according to claim 8, wherein the housing comprises a base frame and an upper frame and the rotary member, the another rotary member, and the developer transferring members are provided at the base frame.

10. The developing device according to claim 9, wherein the base frame is provided at an inside thereof with a hole and the other side of the rotary member is inserted into the hole such that the rotary member is rotatably mounted at the base frame.

11. The developing device according to claim 10, wherein the hole has a depth greater than at least a length of the rotary member inserted into the hole by a length equivalent to a height of the first coupling of the rotary member.

12. The developing device according to claim 1, wherein the rotary member is provided at an outside of the other side thereof with an elastic member support part in a protruding state and the elastic member provides elastic force in a direction to push the elastic member support part to the agitating gear while being supported by the elastic member support part.

13. The developing device according to claim 12, wherein, when the developer is uniformly distributed in the developer receiving compartment such that the rotary member is rotated, the first coupling of the rotary member is rotated while being engaged with the second coupling.

14. The developing device according to claim 1, wherein at least one selected from between one side of the second coupling and one side of the first coupling of the rotary member contacting the side of the second coupling is more gently inclined than the other.

15. The developing device according to claim 1, wherein the other side of the agitating gear is rotated by power transmitted from a motor and the rotary member is rotated in a state in which the first coupling is engaged with the second coupling.

16. The developing device according to claim 1, wherein the rotary member is provided at an outside thereof with an agitating part to agitate developer received in the developer receiving compartment in a protruding state.

17. The developing device according to claim 16, wherein the agitating part is integrally injection-molded with the rotary member.

18. The developing device according to claim 16, wherein the agitating part comprises an agitating film.

19. An image forming apparatus comprising:
an apparatus body forming an external appearance thereof;
a photoconductor, disposed in the apparatus body, on which an electrostatic latent image is formed; and
a developing device to supply developer to the photoconductor, wherein the developing device comprises:
a housing having a developer receiving compartment to receive developer defined therein;
a rotary member rotatably mounted in the developer receiving compartment such that the rotary member is movable in an axial direction;
an agitating gear connected to one side of the rotary member to transmit rotational force to the rotary member; and
an elastic member mounted at the rotary member to provide elastic force in a direction to push the rotary member to the agitating gear side, and wherein
the agitating gear is provided at one side thereof with a second coupling, the rotary member is provided at one side thereof with a first coupling engaged with the second coupling, and the second coupling and the first coupling are rotated in an engaged state.

20. The image forming apparatus according to claim 19, wherein, when the rotary member is not rotated due to the developer non-uniformly distributed in the developer receiving compartment, the second coupling is rotated such that the second coupling slides along the side of the first coupling and passes the first coupling to move the rotary member in the axial direction.

21. The image forming apparatus according to claim 20, wherein, when the second coupling slides along the side of the first coupling, the rotary member is moved to an other side of the rotary member and, when the second coupling has passed the first coupling of the rotary member, the rotary member is moved to the agitator gear side by elastic force of the elastic member such that the second coupling is engaged with the first coupling.

22. The image forming apparatus according to claim 21, wherein the rotary member repeatedly performs reciprocation in which the rotary member is moved to the other side of the rotary member and then moved to the agitator gear side until the rotary member is rotatable to agitate the developer in the developer receiving compartment.

23. The image forming apparatus according to claim 22, wherein at least one selected from between one side of the second coupling and one side of the first coupling contacting the side of the second coupling is more gently inclined than the other.
